(19) United States
(12) Patent Application Publication
(10) Pub. No.: US 2018/0134063 A1
(43) Pub. Date: May 17, 2018

(54) SHAPED MICROLENSES

(71) Applicant: CCL Secure Pty Ltd, Craigieburn, Victoria (AU)

(72) Inventor: Gary Fairless Power, Craigieburn, Victoria (AU)

(73) Assignee: CCL Secure Pty Ltd, Craigieburn, Victoria (AU)

(21) Appl. No.: 15/574,430

(22) PCT Filed: May 13, 2016
(86) PCT No.: PCT/AU2016/050364

§ 371 Date: Nov. 15, 2017

(30) Foreign Application Priority Data
May 15, 2015 (AU) 2015100643
May 15, 2015 (AU) 2015901764

(51) Int. Cl. B42D 25/342; G02B 3/00; B42D 25/324

(52) U.S. Cl. CPC B42D 25/342; B42D 25/378; B42D 25/324; G02B 3/0037

(57) ABSTRACT

An optical device, preferably a security device for a document, comprising an arrangement of microlenses and an arrangement of microimages, wherein the arrangement of microimages is configured for providing an optically variable effect when viewed through the arrangement of microlenses, and wherein arrangement of microlenses defines a recognisable image independent to the optically variable effect.

### FIELD OF THE INVENTION

The invention generally relates to optical devices, in particular optical devices suitable for providing enhanced security when provided on documents.

### BACKGROUND TO THE INVENTION

For many reasons, it is often necessary to provide security against counterfeiting of documents. It is common to include a feature on the document which provides an optically variable effect, that is, one where the appearance of the feature changes as the viewing conditions are changed. A common example is the provision on certain documents such as credit cards of a holographic feature, where the appearance changes with viewing angle and illumination angle.

A counterfeiter cannot simply use standard photocopiers to create counterfeit versions of documents containing optically variable effects, as the photocopiers will not accurate reproduce the variable component of the effect. A person, when presented with a counterfeit document, can readily identify it as illegitimate due to the lack of variability.

It is known to provide on some documents, such as passports, banknotes, credit and debit cards, etc., arrays of small lenses, usually referred to as microlenses. The arrays are typically provided in a rectangular or square arrangement, as these are simple to reproduce on a large scale using existing known techniques. However, utilising the rectangular or square shape can allow for easier illicit reproduction of the optical effect.

### SUMMARY OF THE INVENTION

The present invention is directed towards the realisation that providing the microlenses in an arrangement that itself constitutes a recognisable image can provide additional security, as it is more difficult for a counterfeiter to accurately reproduce the recognisable image. In this way, not only do the microlenses produce a security effect due to known arrangements with printed elements (such as arrays of microimages), they provide an additional security effect through acting as pixels of the recognisable image.

The present invention is also directed towards the realisation that a recognisable image provides additional security as the casual user may be intrigued by the unusual arrangement.

According to an aspect of the present invention, there is provided an optical device comprising an arrangement of microlenses and an arrangement of microimages, wherein the arrangement of microimages is configured for providing an optically variable effect when viewed through the arrangement of microlenses, and wherein the arrangement of microlenses defines a recognisable image, through the presence or absence of the microlenses in a regular lattice, independent to the optically variable effect.

Prior art methods of forming microlenses on a substrate using embossing either emboss the entire substrate (this may be particularly applicable to optical devices implemented as a foil) or a strip crossing from a side of the substrate to its opposite side (this may be particularly applicable to optical devices formed directly onto a document substrate). In either case, the microlenses extend from at least one side of a substrate to another. The “recognisable image” is instead preferably defined by an arrangement of microlenses that are located within the bounds of the substrate; the microlenses are not formed at the actual substrate boundaries. More preferably, the “recognisable image” is one that is selected to be identifiable as an image; that is, a user viewing the arrangement of microlenses understands that an image has been defined.

The “recognisable image” may be one that is not a simple geometric shape. In one implementation, a “simple geometric shape” may be a square or rectangle. In another implementation, a “simple geometric shape” is selected from shapes having a small number of straight edge sides, for example, less than 10, preferably less than 5, and more preferably 3 or 4 sides.

Optionally, the “recognisable image” corresponds to an information bearing symbol (or symbols), such as a currency symbol, national identifier, etc.

Typically, the optical device constitutes a security device, being a feature applied to or formed on a document in order to increase the difficulty of producing passable counterfeits of the document.

In an embodiment, the optically variable effect is a moiré effect. In another embodiment, the optically variable effect is a contrast switch effect.

Typically, the recognisable image is defined by the presence of microlenses.

Preferably, a complete grid of microlens positions is determined and microlenses are selectively placed at grid locations of the complete grid thereby creating the recognisable image.

Optionally, the arrangement of microimages extends over a larger area than the arrangement of microlenses.

In an embodiment, the arrangement of microlenses is fixedly located opposite the arrangement of microimages, preferably located on opposing sides of an at least substantially transparent substrate. In an alternative embodiment, the arrangement of microlenses is located separately to the arrangement of microimages, such that arrangements must be brought into an overlapping relationship in order to view the optically variable effect, preferably wherein the arrangements are located in different areas of a substrate.

Optionally, the microlenses are spherical or aspherical microlenses, or the microlenses are cylindrical microlenses. Another option is to utilise cylindrical microlenses which are selectively absent, thereby defining the recognisable image.

According to another aspect of the present invention, there is provided a document, preferably a security document and more preferably a banknote, comprising the optical device of the first aspect.

In one embodiment, the arrangement of microlenses is located fixedly opposite the arrangement of microimages within a window or half-window region of the document. In another embodiment, the arrangement of microlenses is located in a window region of the document, and the arrangement of microimages is located separately to the arrangement of microlenses such that the document is required to be manipulated, for example by folding and/or twisting, in order to bring the arrangement of microimages and the arrangement of microlenses into an overlapping relationship in order to view the optically variable effect. Typically in this case, the arrangement of microimages extends over a larger surface area of the document than the arrangement of microlenses.

Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable devices described herein may also have application in other products, such as packaging.

Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET), biaxially-oriented polypropylene (BOPP); or a composite material of two or more materials, such as a laminate of paper and at least one plastic material, or of two or more polymeric materials.

Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

Diffractive Optical Elements (DOEs)

As used herein, the term diffractive optical element refers to a numerical-type diffractive optical element (DOE). Numerical-type diffractive optical elements (DOEs) rely on the mapping of complex data that reconstruct in the far field (or reconstruction plane) a two-dimensional intensity pattern. Thus, when substantially collimated light, e.g. from a point light source or a laser, is incident upon the DOE, an interference pattern is generated that produces a projected image in the reconstruction plane that is visible when a suitable viewing surface is located in the reconstruction plane, or when the DOE is viewed in transmission at the reconstruction plane. The transformation between the two planes can be approximated by a fast Fourier transform (FFT). Thus, complex data including amplitude and phase information has to be physically encoded in the micro-structure of the DOE. This DOE data can be calculated by performing an inverse FFT transformation of the desired reconstruction (i.e. the desired intensity pattern in the far field).

DOEs are sometimes referred to as computer-generated holograms, but they differ from other types of holograms, such as rainbow holograms, Fresnel holograms and volume reflection holograms.

Refractive Index n

The refractive index of a medium n is the ratio of the speed of light in vacuum to the speed of light in the medium. The refractive index n of a lens determines the amount by which light rays reaching the lens surface will be refracted, according to Snell's law:

n₁*Sin(α)=n*Sin(θ),

where α is the angle between an incident ray and the normal at the point of incidence at the lens surface, θ is the angle between the refracted ray and the normal at the point of incidence, and n₁ is the refractive index of air (as an approximation n₁ may be taken to be 1).

Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. The curing process does not take place before the radiation curable ink is embossed, but it is possible for the curing process to take place either after embossing or at substantially the same time as the embossing step. The radiation curable ink is preferably curable by ultraviolet (UV) radiation. Alternatively, the radiation curable ink may be cured by other forms of radiation, such as electron beams or X-rays.

The radiation curable ink is preferably a transparent or translucent ink formed from a clear resin material. Such a transparent or translucent ink is particularly suitable for printing light-transmissive security elements such as sub-wavelength gratings, transmissive diffractive gratings and lens structures.

In one particularly preferred embodiment, the transparent or translucent ink preferably comprises an acrylic based UV curable clear embossable lacquer or coating.

Such UV curable lacquers can be obtained from various manufacturers, including Kingfisher Ink Limited, product ultraviolet type UVF-203 or similar. Alternatively, the radiation curable embossable coatings may be based on other compounds, eg nitro-cellulose.

The radiation curable inks and lacquers used herein have been found to be particularly suitable for embossing microstructures, including diffractive structures such as diffraction gratings and holograms, and microlenses and lens arrays. However, they may also be embossed with larger relief structures, such as non-diffractive optically variable devices.

The ink is preferably embossed and cured by ultraviolet (UV) radiation at substantially the same time. In a particularly preferred embodiment, the radiation curable ink is applied and embossed at substantially the same time in a Gravure printing process.

Preferably, in order to be suitable for Gravure printing, the radiation curable ink has a viscosity falling substantially in the range from about 20 to about 175 centipoise, and more preferably from about 30 to about 150 centipoise. The viscosity may be determined by measuring the time to drain the lacquer from a Zahn Cup #2. A sample which drains in 20 seconds has a viscosity of 30 centipoise, and a sample which drains in 63 seconds has a viscosity of 150 centipoise.

With some polymeric substrates, it may be necessary to apply an intermediate layer to the substrate before the radiation curable ink is applied to improve the adhesion of the embossed structure formed by the ink to the substrate. The intermediate layer preferably comprises a primer layer, and more preferably the primer layer includes a polyethylene imine. The primer layer may also include a cross-linker, for example a multi-functional isocyanate. Examples of other primers suitable for use in the invention include: hydroxyl terminated polymers; hydroxyl terminated polyester based co-polymers; cross-linked or uncross-linked hydroxylated acrylates; polyurethanes; and UV curing anionic or cationic acrylates. Examples of suitable cross-linkers include: isocyanates; polyaziridines; zirconium complexes; aluminium acetylacetone; melamines; and carbodiimides.

Metallic Nanoparticle Ink

As used herein, the term metallic nanoparticle ink refers to an ink having metallic particles of an average size of less than one micron.

### BRIEF DESCRIPTION OF THE DRAWINGS

Embodiments of the invention will now be described with reference to the accompanying drawings. It is to be appreciated that the embodiments are given by way of illustration only and the invention is not limited by this illustration. In the drawings:

FIG. 1a shows a document such as a security document having an optical device according to an embodiment;

FIGS. 1b to 1d show different implementations of a document comprising an optical device;

FIG. 2a shows a side view of an optical device and FIG. 2b shows a plan view of the same device;

FIG. 3a shows a complete grid and FIG. 3b shows microlenses selectively applied to locations within the complete grid;

FIG. 4a shows microlenses selectively applied to locations within the complete grid superimposed with an arrangement of microlenses configured for creating a moiré effect;

FIGS. 4b and 4c show different implementations of the arrangement of microimages and the arrangement of microlenses of FIG. 4a;

FIG. 5 shows an implementation having the arrangement of microimages and the arrangement of microlenses being separately located;

FIGS. 6a and 6b show a contrast-switch embodiment;

FIG. 7 shows a protective layer applied to the arrangement of microlenses;

FIG. 8 shows an alternative embodiment utilising cylindrical lenses;

FIG. 9a shows a prior art foil comprising microlenses; and

FIG. 9b shows a prior art document comprising microimages.

### DESCRIPTION OF PREFERRED EMBODIMENT

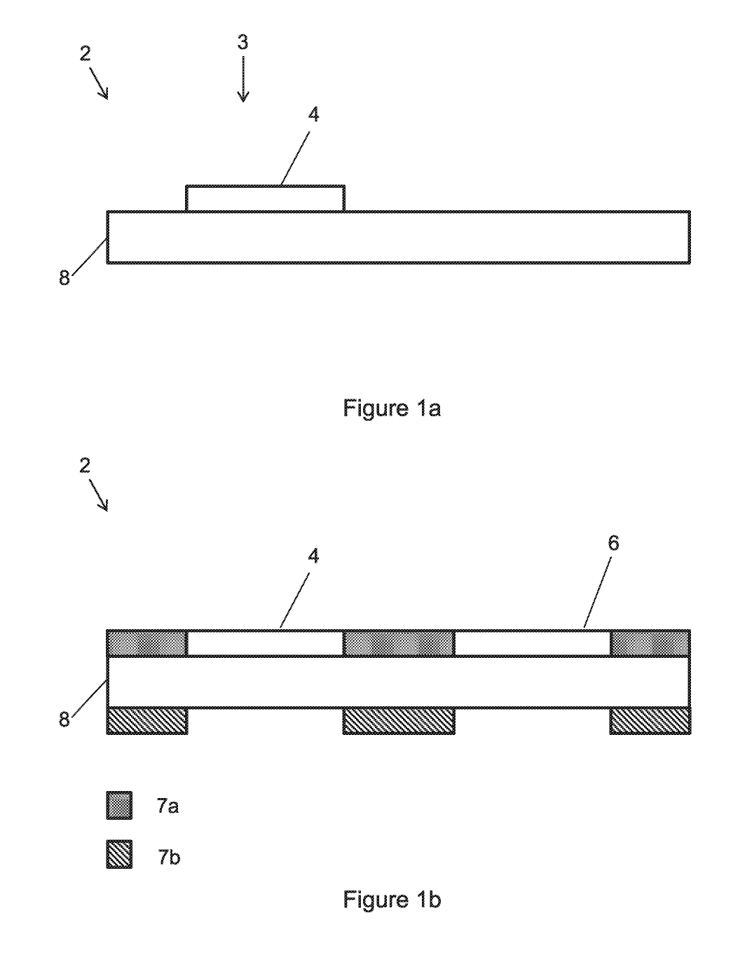

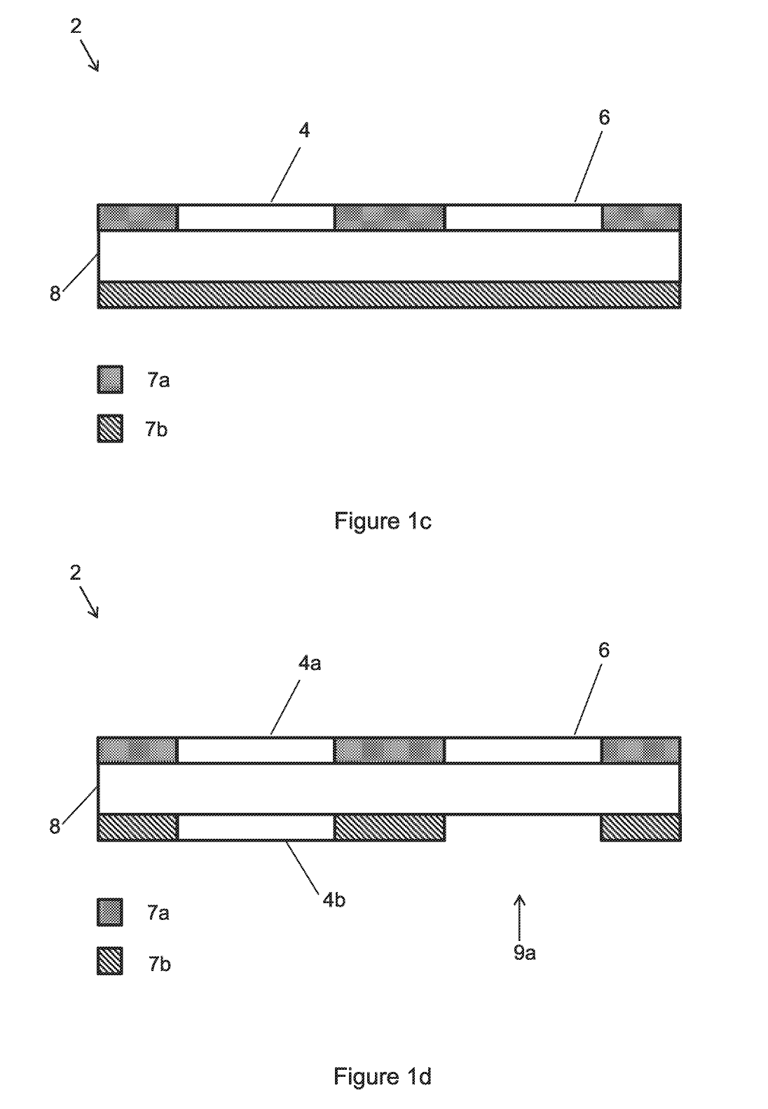

A document 2 including an optical device 4 is shown in FIG. 1a. Typically, the optical device 4 is a security device and the document 2 is a security document, the optical device 4 provided in order to aid in deterring and/or avoiding counterfeiting of the document 2. The document 2 includes a transparent or translucent substrate 8. The optical device 4 can also include a substrate 8, which can be the same substrate 8 as the document 2, or a separate substrate 8.

One possible arrangement of optical device 4 and document 2 is shown in FIG. 1b. First and second opacifying layers 7a, 7b are located on opposing surfaces of substrate 8. The optical device 4 is located in a full window region 5a of the document 2, where both the first and second opacifying layers 7a, 7b are absent in the region of the optical device 4. Though the opacifying layers 7a, 7b are shown contiguous with the optical device 4, this is not necessary. For example, there may be a gap between the edge of the optical device 4 and the edge of the opacifying regions 7a, 7b.

Another possible arrangement of optical device 4 and document 2 is shown in FIG. 1c. As shown, first and second opacifying layers 7a, 7b are located on opposing surfaces of substrate 8. In this arrangement, the optical device 4 is located in a half-window region 5b of the document 2, where first opacifying layer 7a is absent, and where second opacifying layer 7b is present, in the region of the optical device 4. Similar to the arrangement of FIG. 1c, although opacifying layer 7a is shown contiguous with the optical device 4, this is not necessary. In embodiments, the second opacifying layer 7b includes printed features located opposite and visible through optical device 4.

Two more arrangements of optical device 4 and document 2 are shown in FIGS. 1d and 1e. The optical device 4 is separated into first and second components 4a, 4b. The first component 4a is located in one location on the substrate 8 and the second component 4a is located in another location on the substrate 8. In FIG. 1d, the components 4a, 4b are located fixedly overlapping each other, with the substrate 8 separating them. In FIG. 1e, the components 4a, 4b are located non-opposite one another, such that the document 2 must be manipulated, for example through folding and/or twisting, in order to bring the components 4a, 4b into an overlapping arrangement.

The arrangements of FIGS. 1d and 1e are particularly suitable where the optical device 4 is formed directly onto the document 2, rather than being formed as a separate feature and subsequently applied in whole. Optionally, one of the components 4a, 4b is not required to be transparent and can therefore be covered by an opacifying layer 7a, 7b.

Opacifying layers 7a, 7b separate from an underlying substrate 8 are not necessarily required where the substrate 8 is opaque (such as paper substrates).

FIGS. 1b to 1e each include a further security feature 6, which may, for example, be selected from: windows; diffractive optical devices; holograms; microlens based optical variable devices; and any other suitable security feature(s), and can be located within window or half-window regions of the substrate 8 as necessary and/or desired (for example, FIG. 1b shows the further security feature 6 located in a window region, and FIG. 1c shows the further security feature located in a half-window region). Similar to the optical device 4, the further security feature 6 can correspond to a foil applied to a surface of the document 2 (for example, as shown in FIG. 1d). A further security feature 6 can also be located within the same window or half-window region of the document 2 as the optical device 4.

In general, there are a variety of techniques for incorporating the optical device 4 as described herein onto a document 2. For example, the optical device 4 may be formed separately to the substrate 8 of the document 2 (for example, as a foil), which is subsequently applied to the substrate 8. Another example is the formation of the optical device 4 directly onto the substrate, for example through printing or embossing processes. For the purposes of this disclosure, it will be assumed that the optical device 4 is formed directly onto the document 2, and as such shares as its substrate the substrate 8 of the document 2.

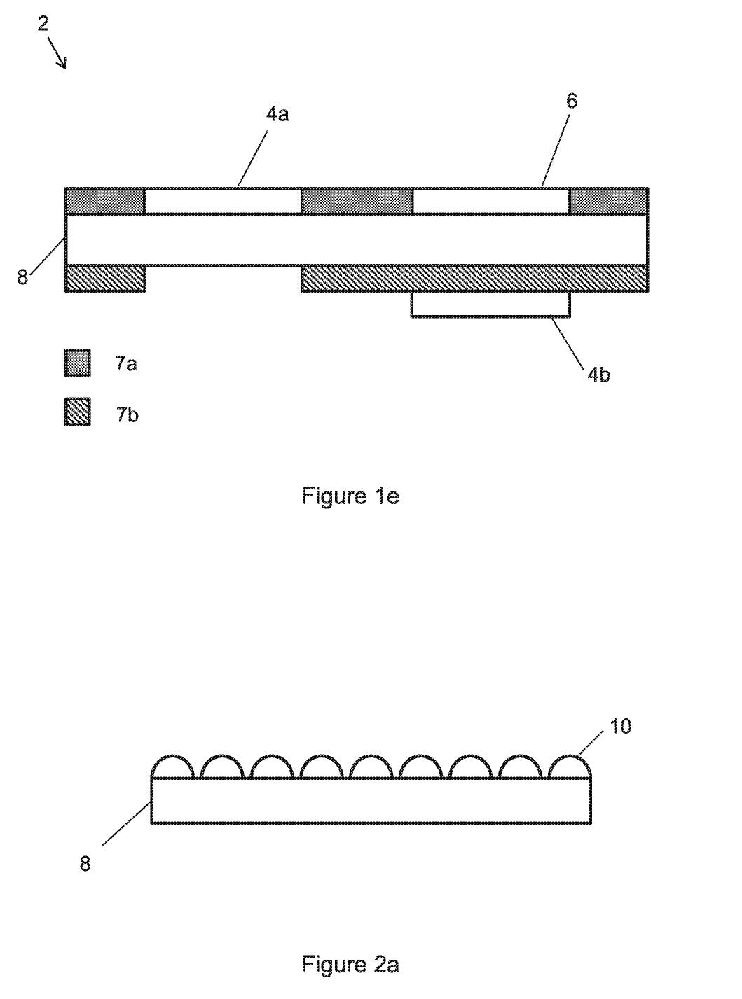

Referring to FIGS. 2a and 2b, the optical device 4 according to an embodiment is shown. The optical device 4 includes an arrangement of spherical or aspherical (not shown) microlenses 10, which can be formed through an embossing process utilising a radiation curable ink, such as disclosed in the applicant's PCT publication number WO 2008/031170 A1. FIG. 2a shows a side-on view of the substrate 8, and FIG. 2b shows a plan view.

As shown in FIG. 2b, the layout of the microlenses 10 defines a recognisable image 12 (in this case, an upper case “A”). This provides an additional security to existing microlens arrangements, which are simply four-sided geometric shapes, that is, square or rectangular.

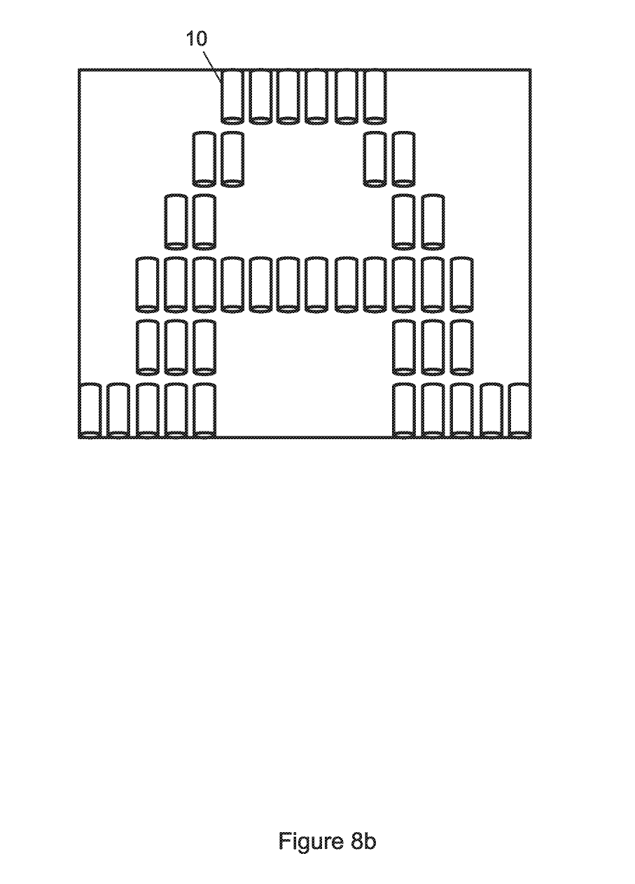

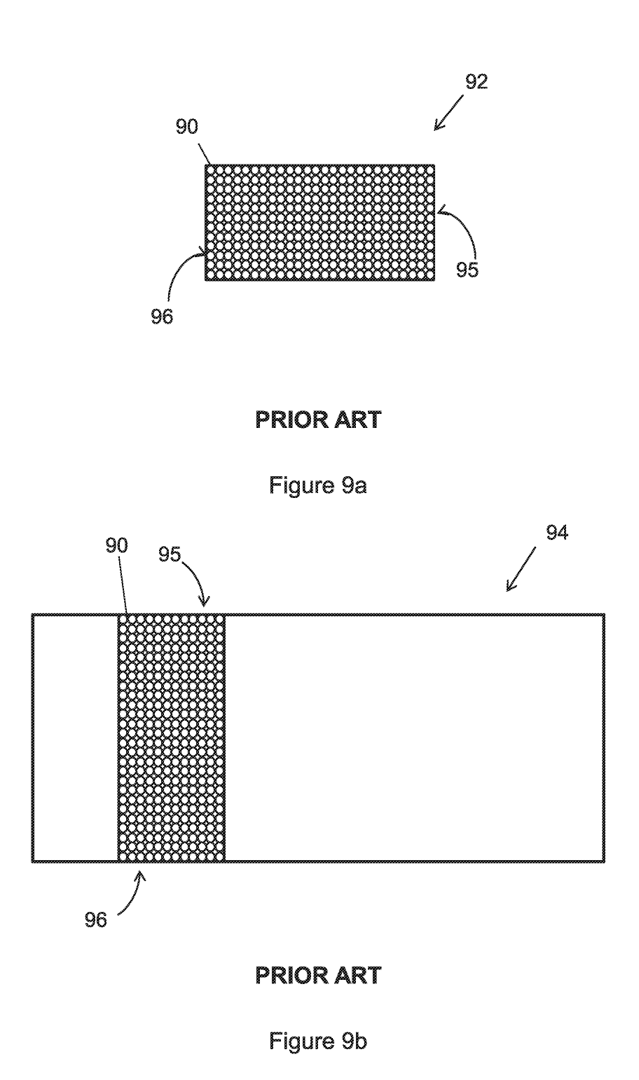

FIGS. 9a and 9b show prior art arrangements of embossed microlenses 90 formed on a foil substrate 92 (FIG. 9a) and a document substrate 94 (FIG. 9b). As can be seen, the prior art microlenses 90 extend from at least one side 95 of the substrate 92, 94 to the opposite side 96. In the case of the foil substrate 92, the microlenses 90 extend over the entire foil substrate 92. In each case, the arrangement of microlenses 90 does not constitute a recognisable image, as the arrangement of microlenses 90 is not located entirely within (and not extending to) edges of the substrate 92, 94.

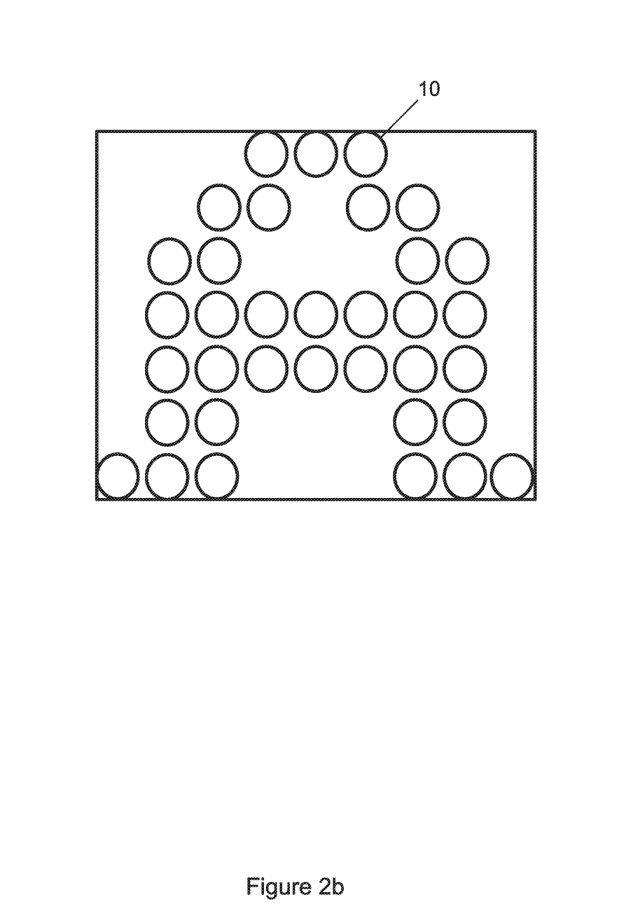

The microlenses 10 defining the recognisable image 12 are selectively formed in locations corresponding to grid positions on a standard grid 20, as shown in FIGS. 3a and 3b. The standard grid 20 corresponds to a regular array of possible grid positions 22 (each grid position 22 is shown as a dotted outline of a spherical microlens). The standard grid 20 shown is a rectangular lattice, however it is understood that any regular lattice can be utilised (such as one of the five two-dimensional Bravais lattices). Alternatively, the standard grid 20 corresponds to a non-regular grid, which may optionally be predetermined using any of a number of well known means, for example corresponding to a regular or periodic change is spacing. The recognisable image 12 is then created by selectively placing microlenses 10 on the grid positions 22 corresponding to the intended image. As shown in FIG. 3b, the recognisable image 12 of an “A”.

Typically, a shim is created for forming, through embossing, the arrangement of microlenses 10. E-beam (electron beam) lithography may be particularly useful in the process of creating the shim, as it allows for precise control of the formation and location of the microlenses 10. Alternatively, a suitable embossing surface can be engraved with the required negative relief structures. For example, a diamond stylus can be used to engrave directly onto a metal cylinder suitable for using in-line in a gravure printing process.

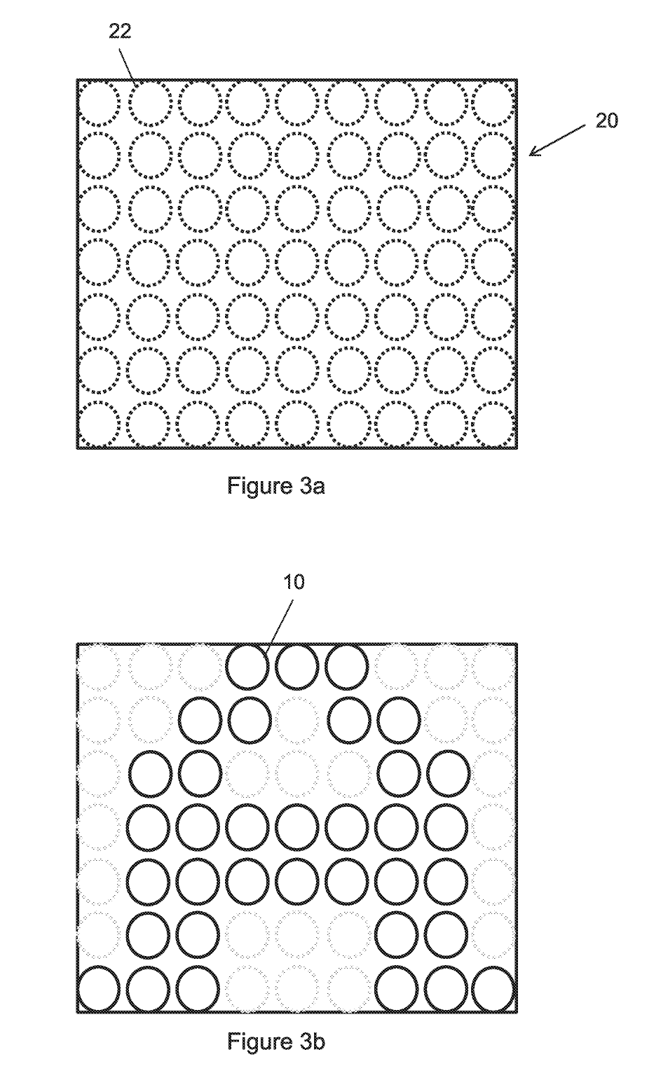

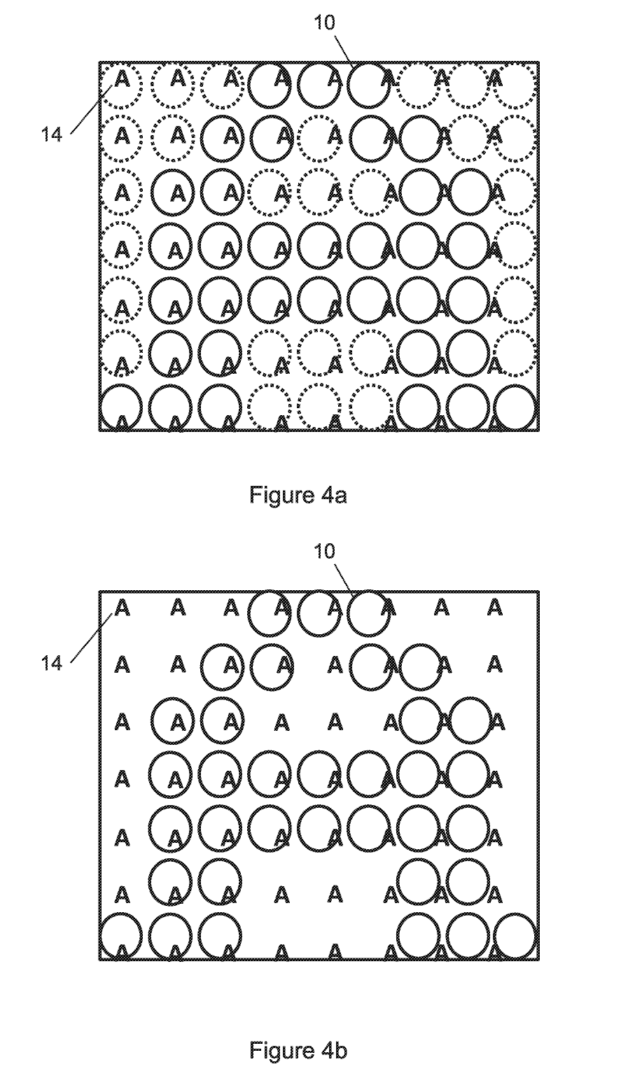

Referring to the embodiment of FIG. 4a, the microlenses 10 are utilised to provide a moiré effect. A moiré effect is produced when the microlenses 10 overlap and focus onto a microimage grid 14. The spacing of the microimages is close to, but not equal to, the spacing of the microlens positions 22 and/or the microimage grid 14 and the standard grid 20 are misaligned through rotation with respect to one another (not shown). The standard grid 20 and the microimage grid 14 are the same lattice-type. General lens-based moiré methods and designs, utilising regular square or rectangular arrangements, are well known in the art.

As microlenses 10 are selectively located on the standard grid 20, the moiré effect will appear “bound” within the outline of the recognisable image 12. This provides an enhanced visual effect compared to prior art moiré arrangements, as the moiré magnified effect is combined with the recognisable image 12.

FIG. 4b shows an implementation of the embodiment of FIG. 4a where the microimages of the microimage grid 14 are printed in their entirety. The microimages that are printed in areas without a corresponding microlens 10 may therefore be visible to a user, thereby providing an interesting juxtaposition between the moving, magnified moiré images and the microimages.

FIG. 4c shows another implementation where microimages are only printed in positions corresponding to the positions of microlenses 10. This implementation may be even more difficult to counterfeit, as it requires accurate registration between the printed microimages and the microlenses 10.

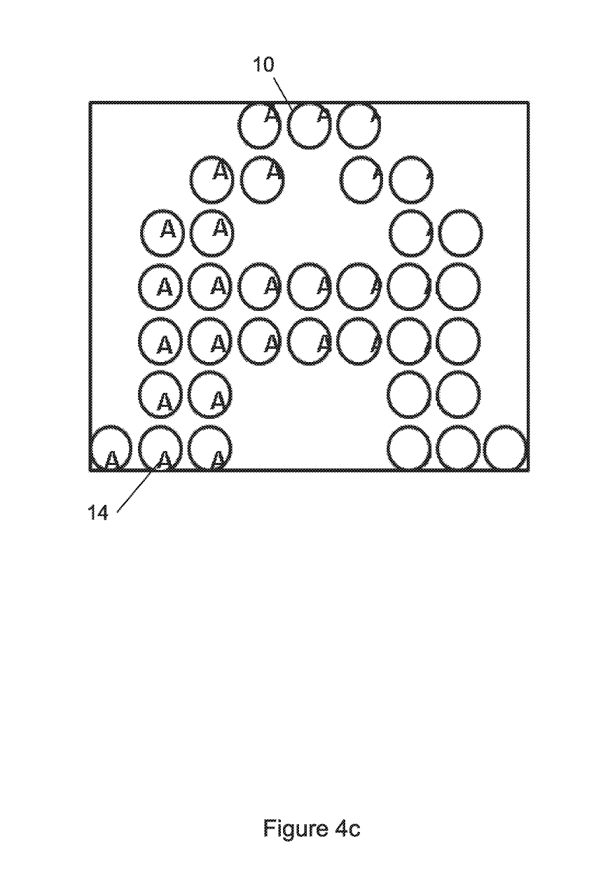

FIG. 5 shows another embodiment, sometimes referred to as a hidden or covert arrangement, where the microlenses 10 and microimages are not fixedly located with respect to one another. In order for a user to observer the moiré magnification effect, the microlenses 10 must be brought into a position overlapping the microimages. A user is then able to move the microlenses 10 and microimages with respect to one another (either or both of a transverse relative movement and a rotational relative movement) and/or tilt the two layers, causing a relative motion and/or rotation and/or expansion of the magnified moiré image. Despite the movement of the magnified moiré image, it is still constrained within the boundary of the recognisable image. When the microlenses 10 and the microimages are located in different parts of the same document 2 (as shown in FIG. 1e), a “self-verification” security arrangement can be created.

In an implementation of this embodiment, the microimage array extends over a larger surface area than the microlenses 10, such that the user is not required to exactly align the two layers. As the user tilts the combined layers and/or moves the layers with respect to each other, a moiré effect is viewed.

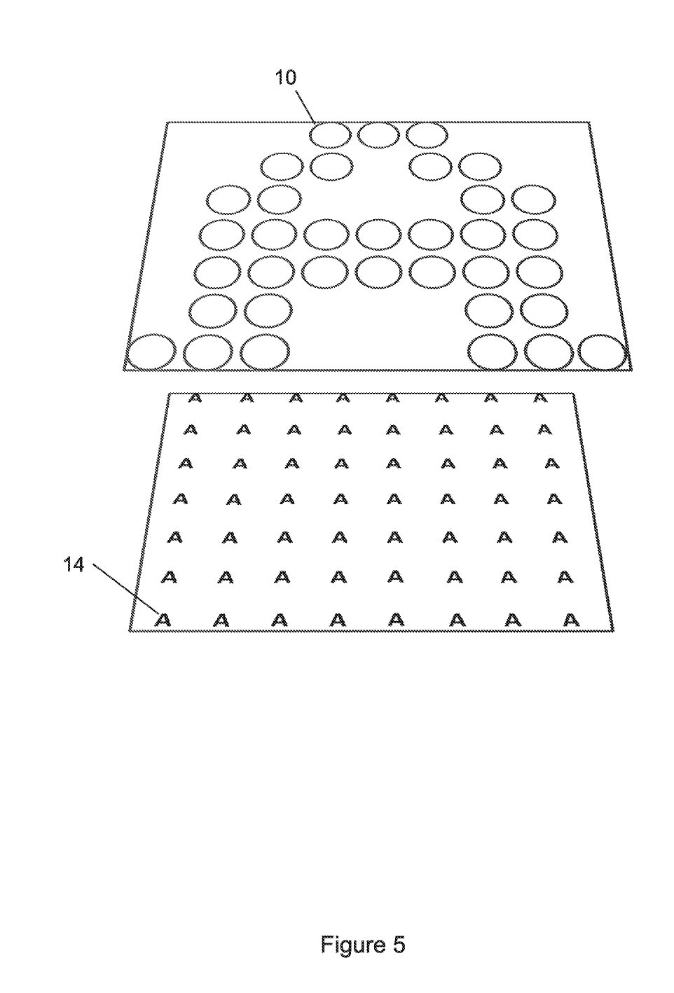

FIGS. 6a and 6b show an embodiment utilising a contrast switch effect. This embodiment utilises microimage spacing equal to that of the standard grid 20. According to the implementation shown, each microimage 14 is configured to roughly half of the area associated with the microimage 14 is coloured a first colour (e.g. black), and the other half coloured a second colour (e.g. white). An alternative implementation, not shown, does not require each microimage 14 to be composed of half of one colour, half of another, and instead allows for other colouring options. This embodiment may be particularly suitable for arrangements where the microlenses 10 and microimages 14 are located separately such that they must be brought together as previously described with reference to FIG. 5, in which case the microimages 14 are printed over a larger area than that covered by the microlenses 10, as shown in FIG. 6b. It is understood that one of the colours may constitute no printed ink, or a transparent ink, such that the colour constitutes the underlying substrate 8 colour (or opacifying layer 7a, 7b colour).

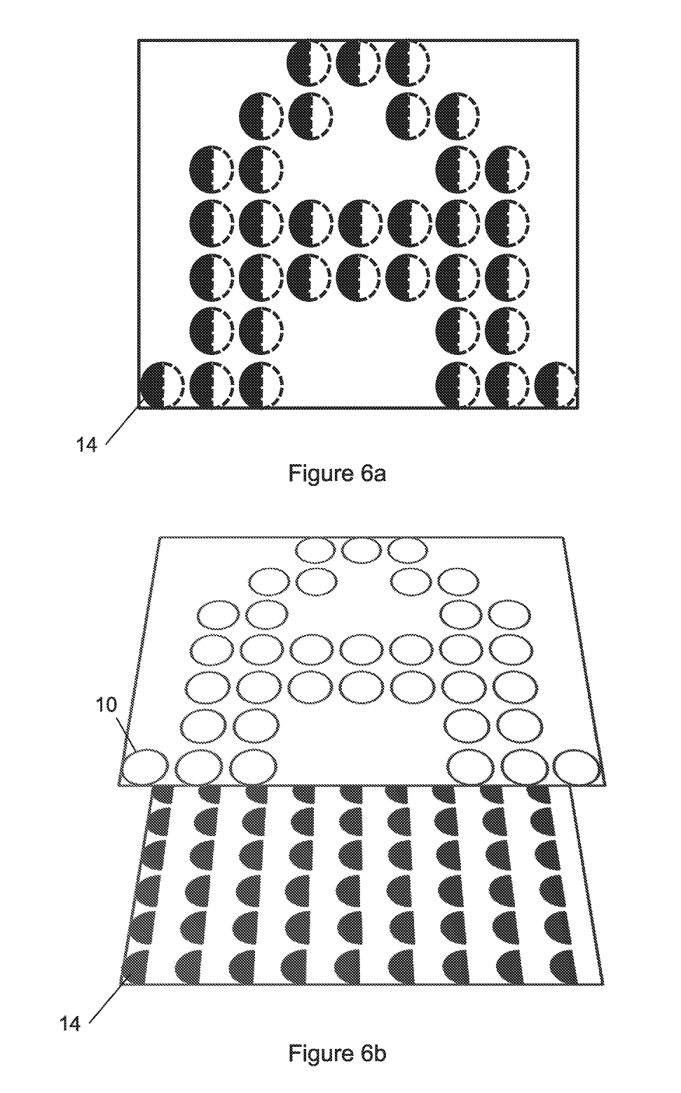

A protective coating 24 can be applied to the outward facing surface of the microlenses 10, as shown in FIG. 7. The protective coating 24 can provide an additional benefit of “flattening out” the outward facing surface, such that the microlenses 10 are tactilely indistinguishable from the non-microlens 10 areas of the surface.

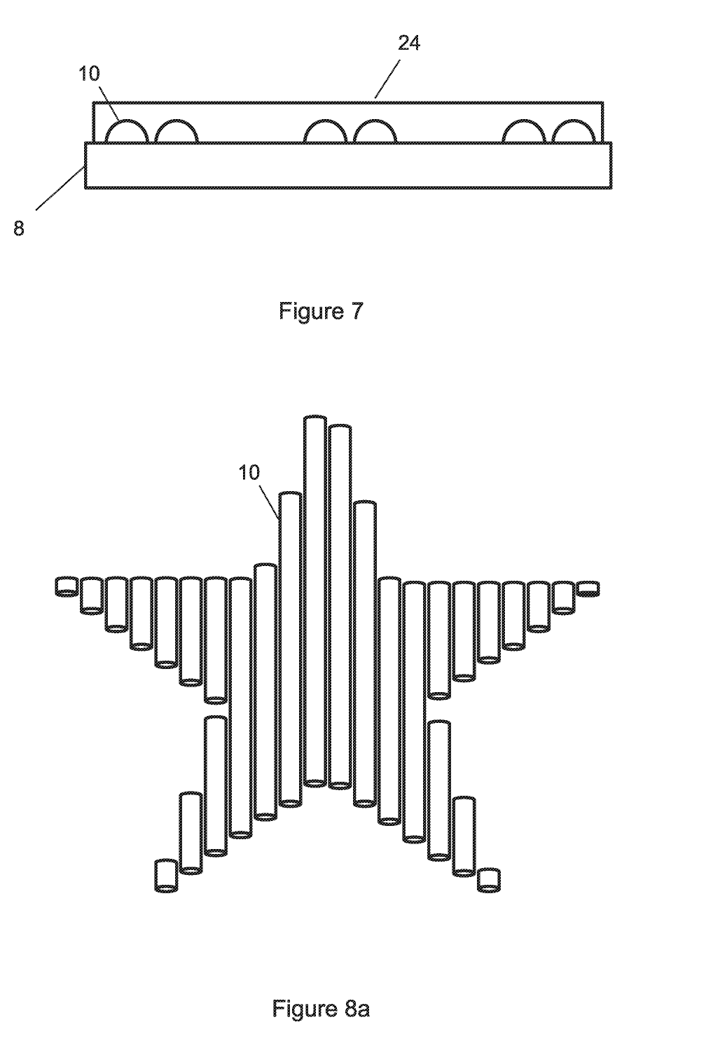

It is envisaged that other microlenses 10 can be utilised, for example, as shown in FIGS. 8a and 8b, an arrangement of cylindrical microlenses 10 are shown configured to provide an identifiable image (a star in FIG. 8a, an “A” in FIG. 8b). In the implementation shown in FIG. 8a, the cylindrical microlenses 10 are applied in a regular array with regions flattened or removed, thereby defining the recognisable image. In the implementation of FIG. 8b, the cylindrical microlenses 10 are formed with a fixed length, and the microlenses 10 are selectively formed on positions within a standard grid 20 as per the embodiments described utilising spherical microlenses 10.

Modification and improvements can be incorporated without departing from the scope of the invention. For example, diffractive and/or Fresnel lenses may be substituted for the refractive microlenses described herein.

The claims defining the invention are as follows:

1. An optical device, preferably a security device for a document, comprising an arrangement of microlenses and an arrangement of microimages, wherein the arrangement of microimages is configured for providing an optically variable effect when viewed through the arrangement of microlenses, and wherein the arrangement of microlenses defines a recognisable image, through the presence or absence of the microlenses in a regular lattice, independent to the optically variable effect.

2. An optical device as claimed in claim 1, wherein the optically variable effect is a moiré effect or wherein the optically variable effect is a contrast switch effect.

3. An optical device as claimed in claim 1, wherein the recognisable image is defined by the presence of microlenses.

4. An optical device as claimed in claim 1, wherein a complete grid of microlens positions is determined and microlenses are selectively placed at grid locations of the complete grid thereby creating the recognisable image.

5. An optical device as claimed in claim 1, wherein the arrangement of microimages extends over a larger area than the arrangement of microlenses.

6. An optical device as claimed in claim 1, wherein the arrangement of microlenses is fixedly located opposite the arrangement of microimages, preferably located on opposing sides of an at least substantially transparent substrate.

7. An optical device as claimed in claim 1, wherein the arrangement of microlenses is located separately to the arrangement of microimages, such that arrangements must be brought into an overlapping relationship in order to view the optically variable effect, preferably wherein the arrangements are located in different areas of a substrate.

8. An optical device as claimed in claim 1, wherein the microlenses are spherical or aspherical microlenses, or wherein the microlenses are cylindrical microlenses.

9. An optical device as claimed in claim 1, wherein the microlenses are cylindrical microlenses selectively absent, thereby defining the recognisable image.

10. A document, preferably a security document and more preferably a banknote, comprising the optical device of claim 1.

11. A document as claimed in claim 10, wherein the arrangement of microlenses is located fixedly opposite the arrangement of microimages within a window or half-window region of the document.

12. A document as claimed in claim 10, wherein the arrangement of microlenses is located in a window region of the document, and wherein the arrangement of microimages is located separately to the arrangement of microlenses such that the document is required to be manipulated, for example by folding and/or twisting, in order to bring the arrangement of microimages and the arrangement of microlenses into an overlapping relationship in order to view the optically variable effect.

13. A document as claimed in claim 12, wherein the arrangement of microimages extends over a larger surface area of the document than the arrangement of microlenses.
